(19) United States
(12) Patent Application Publication
(10) Pub. No.: US 2010/0067723 A1
(43) Pub. Date: Mar. 18, 2010

(54) USER INTERFACE FOR A COMMUNICATIONS DEVICE

(75) Inventors: Martin Bergmann, Smorum (DK); Crilles Bak Rasmussen, Smorum (DK); Bo Littau, Smorum (DK)

Correspondence Address: BUCHANAN, INGERSOLL & ROONEY PC, POST OFFICE BOX 1404, ALEXANDRIA, VA, 22313-1404, US

(73) Assignee: Oticon A/S, Smorum (DE)

(21) Appl. No.: 12/593,999

(22) PCT Filed: Apr. 10, 2008
(86) PCT No.: PCT/EP08/54342

§ 371 Date: Sep. 30, 2009

(30) Foreign Application Priority Data
Apr. 10, 2007 (EP) 07105908.3

(51) Int. Cl. H04R 25/00

(52) U.S. Cl. 381/315; 455/41.2

(57) ABSTRACT

A body worn communications device for communicating with a head-worn listening device, the communications device being adapted for receiving a multitude of audio signals and for transmitting at least one audio signal selected among the multitude of audio signals to the listening device, the communications device having a number of functional push-buttons for influencing the selection and properties of said audio signals. The communications device has a user interface having a number of functional push-buttons for influencing the state of the user interface, such as the selection (and de-selection) of an audio signal, events and properties related to the audio signal, and wherein the state of the user interface is indicated at the same button where the state can be influenced.

### CROSS REFERENCE TO RELATED APPLICATIONS

The present application is a national stage application of PCT/EP2008/054342, filed on 10 Apr. 2008, which claims priority to EP 07105408.3, filed on 10 Apr. 2007, which hereby expressly incorporated by reference.

### TECHNICAL FIELD

The disclosure relates to a communications device for wireless communication with another device. An embodiment of the disclosure relates to a user interface for a body worn communications device for forwarding to a listening device one or more audio signals selected from a number of audio input sources, possibly including that of a mobile telephone. The disclosure further relates to a system, a method and use.

The disclosure may e.g. be useful in applications such as hearing aids, ear phones, head sets, etc.

### BACKGROUND ART

The following account of the art relates to one of the areas of application of the present disclosure, the control of the forwarding of audio signals to a hearing aid.

Hearing aid systems demand increasing ability to communicate with accessories such as mobile phones, MP3 players, etc. Various gateway devices capable of converting these types of data in accordance with a standard or proprietary protocol have been proposed, cf. e.g. EP 1 460 769 A1 or WO 2006/023857 A1 or WO 2006/117365 A1.

### OBJECTS AND SUMMARY

Providing a good, easy-to-use user interface for a relatively complex audio gateway supporting multiple wireless and wired connections as well as mobile phone calls can be a difficult task.

An object of the present disclosure is to provide a relatively simple user interface between an audio selection device and a head-worn listening device, such as a hearing aid. It is a further object to provide a user interface that is particularly adapted to a user wearing a hearing aid.

Objects of the disclosure are achieved by the inventions described in the accompanying claims and as described in the following.

In the present context, the terms ‘hearing instrument’ and ‘hearing aid’ are used interchangeably for a body worn listening device comprising adaptation (e.g. amplification) of an acoustical input (typically customized to the wearers hearing profile). In the present context, a hearing aid/hearing instrument may be of any appropriate kind, such as an in-the-ear (ITE), completely-in-canal (CIC), behind-the-ear (BTE), or a receiver-in-the-ear (RITE) hearing aid.

A Communications Device:

An object of the disclosure is achieved by a body worn communications device for communicating with a head-worn listening device, the communications device being adapted for receiving a multitude of audio signals (e.g. including an audio signal from a mobile telephone) and for transmitting at least one audio signal selected among the multitude of audio signals to the listening device, the communications device comprising a user interface comprising a number of functional push-buttons for influencing the state of the user interface, such as the selection (and de-selection) of an audio signal, events and/or properties related to said audio signal, and wherein the state of the user interface is indicated at the same button where the state can be influenced.

In general, according to the disclosure, the function of a push button combines activation with indication. The purpose of an activation of a push button (which influences the state of the user interface) is to allow a user to initiate (or attempt to initiate) an action (a change of settings, an event) in the communications device and/or in the listening device by issuing a command associated with the button in question. The purpose of an indication is to give the user a possibility to experience the status of current actions (settings, events, indicate the state of the user interface).

The ‘user interface’ is taken to mean the combination of structural and possibly software means that together enable a user to interact with the communications device, i.e. the means that together enable activation and provide indication.

The ‘state of the user interface’ is understood to include events related to a particular functional push-button, e.g. an incoming phone call, an available audio source, etc. It is further understood to include indications of the status, e.g. activeness or non-activeness of the function indicated by a given push-button (e.g. phone call active or not, other audio source active or not, wireless connection active or not). The ‘state of the user interface’ generally relates to a connection or coupling (or at least a part thereof) between the listening device and an audio source providing an audio signal to the listening device mediated by the communications device (i.e. received from the audio source by the communications device and transmitted to the listening device). The ‘state of the user interface’ can e.g. comprise state(s) of the communications device relating to the connection to the listening device (e.g. ‘phone call accepted’). The term may also comprise state(s) of the communications device related to its interaction with other devices (audio sources) (e.g. ‘Bluetooth pairing in progress’)).

In an embodiment, the communications device is adapted to accept an audio signal from a mobile telephone by activating a ‘phone’ push-button on the communications device. This has the advantage that no manipulation of the listening device or the mobile telephone is necessary. The user interface provides a ‘one click’ acceptance (or rejection of an incoming call from a (predefined) mobile telephone). In a Bluetooth environment, a preceding pairing of the mobile telephone to the communications device is preferably performed.

In an embodiment, the indication at a given button is a visual indication. In an embodiment, the user interface is adapted to provide audio-visual cues to communicate its state to the user. This has the advantage that the type of cues can be optimized to the particular needs of the user and/or to the particulars of the device in question (hearing aid/head set). In an embodiment, audio cues related to the state of a given push button are played in the listening device. In particular, cues related to the received audio signal can be indicated as audio cues in the listening device (possibly in addition to corresponding visual indications on the communications device). In an embodiment, the use of audio cues can be configured by a user, e.g. by an on-off button or as a software option.

Apart from indicating a state or an event, the push buttons are adapted to influence the state of the communications device and or the listening device by issuing pre-defined commands to the device(s) in question and thereby to result in events (the status of which are then indicated by the ‘initiating button’). Advantageously, the communications device is adapted to provide that the commands activated by said push-buttons are defined dependent upon a push-time parameter and/or of the simultaneous activation of two or more push-buttons. Preferably, a given push-button activation combination generates a mixture of audio-visual cues to indicate to a user which command is thereby activated. The term ‘command’ is in the present context taken to mean a signal intended for controlling an action (locally or in another device, e.g. in the listening device), e.g. ‘Establish audio stream connection’ or ‘Switch off microphone in listening device’.

Among the advantages for a user (e.g. a hearing impaired user) are:
Clear visual feedback by using simple button light indications
Operation and indication are tied together in the buttons.
The combination of audio and visual indications.

A communications device according to an embodiment of the disclosure enables wireless digital audio to be forwarded to a listening device, such as a hearing aid or a pair of hearing aids without operating the hearing aid(s), i.e. the communications device—in this respect—working as a remote control of the hearing aid(s).

The term ‘push-button’ is in the present context taken to mean any activator for transforming a human input to an electrical signal (command). A push-button in the present context can thus e.g. be a key of a key pad, a touch sensitive area of a panel, such as a touch screen, etc. In an embodiment, a ‘push button’ has a well-defined form adapted to enhance the ease of identification and/or use of the communications device. In an embodiment, the forms of at least some of the push buttons are adapted to their particular function, thereby further improving the user friendliness of the device. In an embodiment, the form of a button is selected from the group of forms comprising a circle, a rectangle, a triangle, and a polygon (number of vertices larger than 4). In an embodiment, a push button has the form of a symbol indicative of the function of the button (e.g. equal to a symbol painted on a button, cf. e.g. (telephone) symbol 113 in FIG. 1). The different form of the buttons provides the advantage that the device can be (at least partially) operated by only feeling the form of the buttons (without specifically looking).

In an embodiment, two or more colours are used for visual button indication, such as three or more, such as four or more colours. In an embodiment, the colours red, green yellow and blue are used for indicating different events or functions. This is an easy to understand way of indicating different meanings of a particular button.

In an embodiment, the communications device is adapted to indicate events relating to said received audio signals to a user by a mixture of audio-visual cues, at least partially via one or more of said push-buttons. A mixture of audio and visual indicators is an efficient way of illustrating to a user a number of different meanings of a relatively small number or push-buttons. An event is e.g. ‘Incoming phone call’.

In an embodiment, the push-time parameter comprises at least two different time ranges, short, long, such as three different time ranges, short, long, very long, each having a different meaning when translated to a corresponding command. The use of a push-time parameter provides an efficient way of enhancing the number of possible commands by a relatively small number of input keys (push-buttons).

In an embodiment, the visual cues for a given button are selected from the group comprising a symbol on the button, button rim lights, back light, different colour light, constant light, no light, blinking light at a first blinking frequency, blinking light at a second blinking frequency, and combinations thereof.

The term ‘rim light’ is in the present context taken to mean a light that surrounds a central area, where the illumination along the rim can be controlled independently of the (optional) light or illumination of the central area.

The term ‘back light’ is in the present context taken to mean the illumination of the key pad (or push-button), typically comprising a symbol indicating the function or relation of the key pad (or push-button). In an embodiment, the back light illuminates the symbol (or the background of the symbol, thereby providing its ‘negative’).

In an embodiment, the audio cues for a given button and/or event are selected from the group comprising ring-tones, clicks, single beep-sounds, a relatively short beep, a relatively long beep, a number of repeated beep-sounds at a first repeat frequency, a number of repeated beep-sounds at a second repeat frequency, one or more recorded voice messages, and combinations thereof.

In an embodiment, the status of the communications device is communicated visually with lights, while the status of the listening device is communicated with audio signals played in the listening device (optionally in addition to a visual indication on appropriate buttons of the communications device).

In an embodiment, the communications device is adapted to provide that one or more events related to an audio signal received by the communications device are communicated with audio signals played in the listening device. In an embodiment, the events for being communicated with audio signals played in the listening device are selected among the group of events comprising 1) an incoming call, 2) an incoming SMS, 3) redial last number, 4) reject call (1)-4) related to a mobile telephone signal), 5) connection enabled, 6) connection disabled, 7) connection lost (5)-7) related to the connection between a signal source and the communications device).

In an embodiment, the audio signals played in the listening device are stored in a memory in the listening device. In an embodiment, such stored signals can be activated via commands forwarded to the listening device from the communications device. Alternatively, the audio signals can also be stored in a memory of the communications device and forwarded to the listening device.

In an embodiment, the communications device comprises a ‘phone’ button for initiating commands and displaying events relating to the audio signal from a telephone and an ‘audio’ button for initiating commands and displaying events relating to another audio signal. This has the effect that the state of the user interface is indicated at the same place where the state can be changed as embodied by the button in question. In an embodiment, the communications device further comprises a volume control button for regulating the volume of the audio signal streamed to the listening device.

In an embodiment, the communications device further comprises a microphone for recording a user's voice input. Such a microphone is e.g. for use in case the selected audio signal is from a telephone. In an embodiment, the communications device further comprises a volume control button for regulating the volume of the audio signal presented to the listening device. In an embodiment, the communications device comprises a wireless audio input, e.g. according to the BlueTooth standard or another standard for digital wireless communication. In an embodiment, the communications device comprises a wireless communications button, e.g. a BlueTooth button. In an embodiment, the communications device further comprises a connector for a wired audio input, such as a jack connector or a USB-connector. In an embodiment, the communications device further comprises a connector for charging the battery of the communications device and/or for updating the firmware of the communications device, e.g. a USB-connector. In an embodiment, the communications device comprises four push buttons, a phone button, an audio button, a volume button and a wireless connection button. This combination of buttons provides a simple and sufficient user interface, wherein the state of the user interface is indicated at the same button where the state can be changed. In an embodiment, the communications device further comprises a battery status indicator. In an embodiment, the connector for charging the battery is located near the battery status indicator, e.g. within 5 cm from each other, such as within 2 cm of each other (measured boundary to boundary).

In an embodiment, the communications device can be handheld and the push-buttons of the communications device are arranged so that they can all be manipulated by a thumb of a normal human hand substantially without mowing the grip on the device. In an embodiment, the push-buttons of the communications device are arranged on the same side of a housing of the communications device. In an embodiment, the push-buttons of the communications device are arranged on the same side of a housing of the communications device within 7 cm of each other (e.g. so that the largest distance of a geometrical curve enclosing the outer boundaries of the push-buttons is smaller than or equal to 7 cm), such as within 6 cm, such as within 5 cm, such as within 4 cm, such as within 3 cm.

In an embodiment, the communications device is adapted to communicate with other devices according to a variety of Bluetooth profiles, e.g. according to one or more (such as all) of the Bluetooth Headset (HS) profile, the Bluetooth Handsfree (HF) profile and the Bluetooth Stereo profile.

In an embodiment, the communications device is adapted to provide one or more tactile cues to indicate commands, status or events in the communications device or in said listening device. This has the advantage that the user can receive different information from the user interface without looking at the communications device.

In an embodiment, the communications device comprises a display. In an embodiment, the display is adapted to be a ‘touch screen’ display, thereby including the functionality of one or more push-buttons. In an embodiment, the display is used to present visual cues, e.g. symbols and/or alphanumeric messages related to the state of the communications device and/or of the listening device.

In an embodiment, the communications device is adapted to work as a remote control of the listening device. In an embodiment, the communications device is adapted to be able to change settings of the listening device, e.g. to change a parameter of a hearing aid program to adapt the hearing aid program to the current listening situation of its wearer. In an embodiment, the communications device comprises one or more push buttons to influence processing parameters of the listening device, e.g. shifting between programs in a hearing instrument. In an embodiment, a volume control button of the communications device can additionally be used to influence processing parameters of the listening device (e.g. to toggle between programs, e.g. by simultaneous activation with another button).

In an embodiment, the communications device is located at least partially in the housing of another device, e.g. a remote control device of the listening device or a mobile telephone (cf. e.g. US 2007/0009123).

A Hearing Aid System:

In an aspect, a hearing aid system is further provided, the system comprising a communications device described above, in the detailed description and in the claims and a listening device wherein the listening device and the communications device are adapted to communicate wirelessly with each other.

In an embodiment, the listening device and the communications device are adapted to communicate inductively with each other. In an embodiment, the communication is one-way from the communications device to the listening device via a uni-directional link.

The communication between the listening device and the communications device can be arranged according to any appropriate standard or format, proprietary or public. In a preferred embodiment, the communication between the listening device and the communications device is arranged according to a communications standard codec, such as G.722 (CCITT G.722 Wideband Speech Coding Standard, the CCITT G.722 wideband speech coding algorithm supporting bit rates of 64, 56 and 48 kbps). Alternatively, other standards could be used, e.g. codecs intended for music, such as MP3 (MPEG Audio Layer 3), AAC (Advanced Audio Coding), etc.

In an embodiment, the audio bit rate is larger than 16 kHz, such as 20 kHz or larger.

In an embodiment, the hearing aid system is adapted to allow the listening device to differentiate in the processing of the audio signals received from the communications device, such as between low- and high-bandwidth signals (e.g. phone and music).

In an embodiment, the system is adapted to exchange status information between the communications device and the listening device and wherein an audio identification field is included.

In an embodiment, the listening device comprises a hearing aid or a pair of hearing aids, a head set or a pair of head phones.

In an embodiment, the hearing aid system is adapted to provide that the status of the communications device is communicated visually with lights, while the status of the listening device, optionally in addition to visual indication on appropriate push buttons, is communicated with audio signals played in the listening device.

In an embodiment, the hearing aid system is adapted to provide that the audio signals to be played in the listening device are stored in a memory in the listening device. In an embodiment, such stored signals can be activated via commands forwarded to the listening device from the communications device.

In an embodiment, the hearing aid system is adapted to provide that the audio signals to be played in the listening device are stored in a memory of the communications device and forwarded to the listening device for being played.

Other features, which can be derived from the corresponding device as described above, in the detailed description and in the claims are intended to be combined with the system, where appropriate.

A Method of Indicating to a User:

In a further aspect, a method of indicating to a user a) commands activated by push-buttons of a body worn communications device for communicating with a head-worn listening device, and b) the status of the communications device and/or of the (possibly, intended status of the) listening device is provided. The communications device is adapted for receiving a multitude of audio signals and for transmitting at least one audio signal (possibly including that of a telephone) selected among the multitude of audio signals to the listening device, the communications device comprising a number of functional push-buttons for influencing the selection and properties of said audio signals. The method comprises indicating to a wearer of the communications device states—including commands, status and events—relating to said audio signal(s) received by the listening device (and possibly influenced by the wearer) at the same button where the state in question can be influenced.

In an embodiment, the indication at a given button is a visual indication.

In an embodiment, the indication to the user of the state relating to a given button is based on audio-visual cues.

In an embodiment, audio cues related to the state of a given push button are played in the listening device.

In an embodiment, a mixture of audio-visual cues are used wherein the commands and status of the communications device are communicated visually with lights in or around said push-buttons, while the status of the listening device (and/or events related to a received and possibly selected or newly available audio signal) is communicated with audio signals played in the listening device.

In an embodiment, a push-time parameter is used to define parameters activated by a given push-button, the push-time parameter comprising at least two different time ranges, short, long, or comprising three different time ranges, short, long, very long, each having a different meaning when translated to a corresponding command.

In an embodiment, the visual cues for a given button and/or status indicator are selected from the group comprising a symbol on the button, button rim lights, back light, different colour light, constant light, no light, blinking light at a first blinking frequency, blinking light at a second blinking frequency, and combinations thereof.

In an embodiment, the audio cues for a given button and/or event are selected from the group comprising ring-tones, clicks, single beep-sounds, a relatively short beep, a relatively long beep, a number of repeated beep-sounds at a first repeat frequency, a number of repeated beep-sounds at a second repeat frequency, and combinations thereof.

In an embodiment, indications of commands or status in the communications device or in the listening device are provided by one or more tactile cues, possibly in combination with audio and/or visual cues. In an embodiment, such tactile indications are provided in the communications device. In an embodiment, such tactile indications are provided in the listening device, or in both. An advantage thereof is that it increases the possibility to indicate relatively many pieces of information with a relatively limited number of buttons and/or indicators.

Other features, which can be derived from the corresponding device and system as described above, in the detailed description and in the claims are intended to be combined with the method, where appropriate.

Use of a Communications Device or a Hearing Aid System:

In a further aspect, use of a communications device or of a hearing aid system as described above, in the detailed description or in the claims is provided.

Further objects of the disclosure are achieved by the embodiments defined in the dependent claims and in the detailed description of the preferred embodiments.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements maybe present. Furthermore, “connected” or “coupled” as used herein may include wirelessly connected or coupled. As used herein, the term “and/or” includes any and all combinations of one or more of the associated listed items.

### BRIEF DESCRIPTION OF DRAWINGS

The disclosure will be explained more fully below in connection with a preferred embodiment and with reference to the drawings in which:

FIG. 1 shows different perspective views of an embodiment of a communications device according to the disclosure.

The figures are schematic and simplified for clarity, and they just show details which are essential to the understanding of the disclosure, while other details are left out. Throughout, the same reference numerals are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from this detailed description.

### DETAILED DESCRIPTION OF THE PREFERRED EMBODIMENTS

In the following an embodiment of a user interface for a communications device for communicating with a head-worn listening device, typically for audio streaming to a pair of hearing aids is described. The communications device is adapted for receiving a multitude of audio signals (including that of a mobile telephone) and for wirelessly transmitting at least one audio signal selected among the multitude of audio signals to the hearing aids. Devices having such functionality or similar functionality are e.g. described in WO 2006/023857 A1 or EP 1 460 769 A1 or WO 2006/117365 A1.

Streaming is e.g. performed at more than 16 kHz, such as at 20 kHz or more, e.g. encoded according to the CCITT G.722 standard. To allow the listening device to differentiate in the processing of the audio signals received from the communications device, e.g. between low- and high-bandwidth signals (e.g. phone and music), an audio identification field can be included in the status information exchanged between the communications device and the listening device. This allows the listening device to switch to a program optimized for the characteristics of the audio content.

In the present context, the term ‘streaming’ is taken to mean the (wired or wireless) forwarding at a certain bit rate of a digitally encoded signal (typically divided in data packets) comprising a specific ‘content’, such as an audio or video content (and possibly various control or messaging data), in the present application typically an audio content.

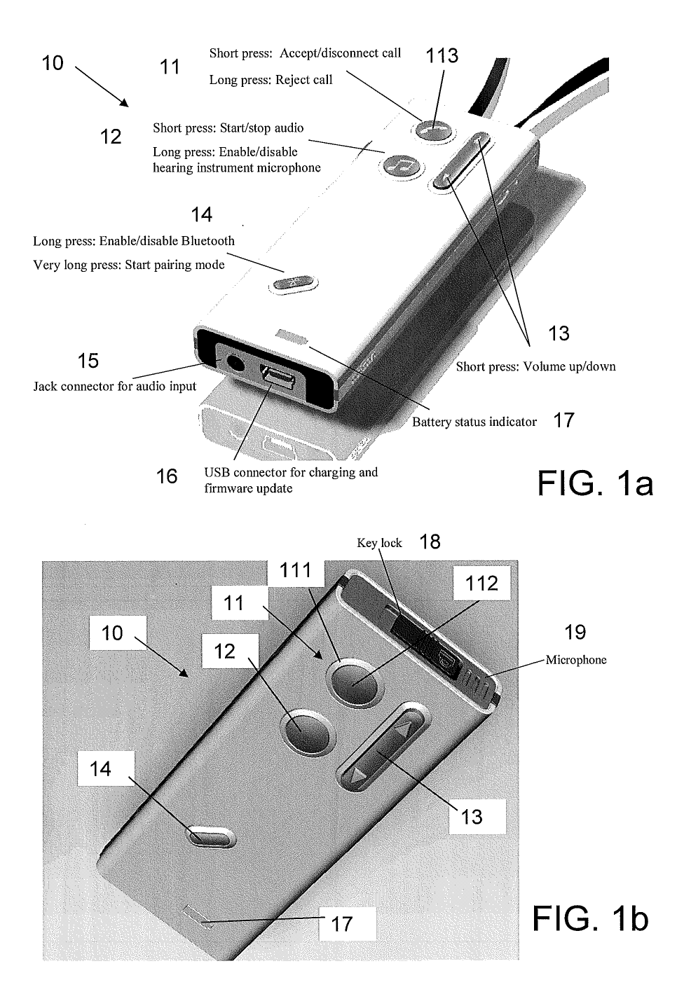

FIG. 1 shows different perspective views of an embodiment of a communications device according to the disclosure.

The present embodiment of a communications device is adapted to receive and forward a telephone call from a mobile telephone to a hearing aid or a pair of hearing aids via a Bluetooth connection between the mobile phone and the communications device. Further, audio signals from other devices can be received and forwarded to the hearing aid(s), including other Bluetooth based signals (e.g. the sound from a TV, a DVD-player or a radio tuner, etc.) or a directly wired signal, here via the jack connector (15 in FIG. 1a) e.g. adapted to receive an audio signal from a music player, such as an iPOD™. In the present embodiment, BlueTooth is used as the wireless transmission standard between an audio source and the communications device. However, other standards could be used, e.g. DECT, IEEE 802.11, etc.

1. Buttons and Connectors Overview

The communications device comprises a number of functional push-buttons for influencing the selection and properties of the audio signals.

The communications device is adapted to provide that the commands activated by the push-buttons are defined dependent upon a push-time parameter and/or of the simultaneous activation of two or more push-buttons. A given push-button activation combination generates a mixture of audio-visual cues to indicate to a user which command is thereby activated.

The individual push-buttons, indicators and connectors of the communications device is described in the following.

FIG. 1a shows the following user-interface features:

Push-Buttons:
Phone button 11 for controlling and indicating events related to a phone call.
Audio button 12 for controlling and indicating events related to audio transmissions other than a phone call.
Volume button 13 for controlling the volume of the audio signal in the hearing aid(s).
Bluetooth button 14 for controlling and indicating events related to the wireless connection to a mobile phone or other audio source.

Indicator:
Battery status indicator 17.

Connectors:
Jack connector 15 for audio input, wired input as an alternative to the wireless (BlueTooth) audio input, e.g. from a music player.
USB connector 16 for battery charging and firmware update.

FIG. 1b shows the following user-interface features:

Other:
Key lock 18 for locking buttons of the communications device to avoid unintentional activation.
Microphone 19 for recording a user's voice input in case of a telephone conversation.

2. Functional Description

This section provides a detailed description of each function, including dependencies on a push-time parameter (here) selectable between ‘short’, ‘long’ or ‘very long’ push-times. The duration of the three button-press-categories of the present embodiment is defined as follows (but could of course be chosen differently in time and number):

Short: 0.1-0.8 seconds

Long: 0.8-2.5 seconds

Very long: >4 seconds

A hearing aid system comprising the communications device of the present embodiment in cooperation with a pair of hearing aids communicating with the head set can act as a mono/stereo wireless (e.g. Bluetooth) headset that also accepts wired input. Examples of uses of such a system are:
Wireless headset for mobile phone (e.g. Bluetooth headset)
Headphones for TV viewing (e.g. Bluetooth headset or wired)
Headphones for e.g. MP3/iPOD™ player (e.g. wired input)
Headphones for Bluetooth stereo music player e.g. MP3 (e.g. Bluetooth stereo)
Volume control for hearing instruments

Push-buttons as shown in the embodiment of FIG. 1 adapted for the various modes described herein can be of any appropriate type, preferably enabling, rim light and possibly back light of a symbol (cf. e.g. 113 in FIG. 1a), letter or text identifying the function of the button.

Audio Streaming

When the hearing instruments are receiving audio from the communications device, all controls on the hearing instruments are locked. The volume in the hearing instruments can be adjusted on the communications device.

Audio streaming is one-way communication from the communications device to the hearing instruments i.e. the communications device has no information about the state of the hearing instruments. When audio streaming is stopped, the communications device instructs the hearing instruments to release controls and resume normal operation. If the hearing instruments for some reason do not receive the ‘stop audio streaming’ messages from the communications device, the hearing instruments must return to normal operation after a predefined timeout-time, e.g. 5 seconds.

In a preferred embodiment, the hearing instrument(s) will only accept audio streaming from the communications device to which they are linked (matched).

Phone button

| | | |
|---|---|---|
| [symbol] | Short press | When a connected phone is ringing, a short press will answer the call. The call is terminated again with a short press. |
| | | The communications device can receive an incoming |
| | | call while streaming other content i.e. wired or |
| | | Bluetooth. |
| | Long | When a connected phone is ringing a long press will |
| | press | reject the incoming call. |

The phone button has no functionality when a call is not incoming or active.

Audio button

| | | |
|---|---|---|
| [symbol] | Short press | A short press toggles audio streaming on/off. The audio source can be wired audio, Bluetooth according to the ‘Bluetooth Headset’ (HS) or ‘Bluetooth Stereo’ profile. Audio sources are prioritized by the communications device in this order: |
| | | 1. Wired audio |
| | | 2. Bluetooth dongle Headset (TV)/Bluetooth |
| | | Stereo |
| | | When no wired connection is present, the |
| | | communications device will attempt to connect to the |
| | | last connected Bluetooth dongle. This will take a few |
| | | seconds and in that time the communications device |
| | | will blink the audio button. |
| | | Note that a phone call has priority over other audio |
| | Long | Turn microphone on/off in hearing instrument while |
| | press | streaming. |
| | | Note that this will reset volume control to 0 |

If more than one Bluetooth audio source is present, e.g. two Bluetooth Stereo devices, the communications device will connect to only one of them. In the present embodiment, it is not possible to switch between multiple Bluetooth sources [except by turning a device off or moving it out of range from the communications device]. Other embodiments may allow such selection among a number of BlueTooth sources whose addresses are pre-recorded in the communications device or in the listening device, cf. e.g. EP 1 328 136.

Bluetooth Button

| | | |
|---|---|---|
| [symbol] | Long press | This toggles Bluetooth on/off in the communications device. |
| | | Bluetooth cannot be turned off during an |
| | | active or incoming call |
| | | The first time the communications device is |
| | | used a long press will activate pairing mode |
| | | [it has no meaning to have Bluetooth on |
| | | without any pairings]. |
| | | Bluetooth can be turned off during Bluetooth |
| | | audio streaming |
| | Very | This activates Bluetooth pairing mode. Bluetooth |
| | long | must be off for the communications device to enter |
| | press | pairing mode. Pairing mode is active for 120 |
| | | seconds and cannot be cancelled. |
| | | Up to 8 devices can be paired at the same time (in |
| | | the sense that a trusted relationship between two |
| | | devices is established prior to the use of such |
| | | devices). When the limit is reached the |
| | | communications device starts overwriting the oldest |
| | | pairings. The communications device is a |
| | | mono/stereo headset and can be for example be |
| | | paired to: |
| | | Mobile phone (Bluetooth headset) |
| | | Mobile phone with music player (Bluetooth |
| | | stereo) |
| | | Bluetooth TV dongle (Bluetooth headset) |
| | | Bluetooth stereo audio adapter |
| | | MP3 player with Bluetooth stereo |
| | | PC and PDA |
| | | GPS car navigation system with Bluetooth |

Special pairing functions:

| | |
|---|---|
| [symbol] | A very long press on Bluetooth AND volume up button simultaneously will delete all pairings in the communications device (prerequisite: Bluetooth must be off). This is useful in refurbishing |

Switching off Bluetooth will significantly increase the battery life of the communications device.

Volume control

| | |
|---|---|
| [symbol] | Short press A short press turns volume up or down in the hearing instruments. Volume is changed in both hearing instruments. The volume control works in all input modes (wired and Bluetooth) and also when the communications device is not streaming audio. |
| | Volume can be turned 4 steps up and 8 steps down |
| | corresponding to 10 dB up (if sufficient reserve gain is present) |
| | and 20 dB down. |

No Audio Streaming:
When the communications device is not streaming audio, the range of operation is boosted ˜30% from the communications device
When the communications device is not streaming audio, the volume control works relative to the hearing instrument setting
When not streaming the volume is binaurally synchronized in the HIs
With only one HI, the volume control works like a ‘local’ VC—with two HIs, the volume control of the communications device operates both

During Streaming:
The volume control is a master volume control, i.e. it affects the hearing instrument microphone as well as the communications device audio
The communications device embeds an absolute volume offset in the audio stream—to ensure that the HIs stay synchronized (binaural synchronization is not possible during audio streaming)
When leaving a program the volume is reset to default (e.g. when the communications device stops audio streaming, the hearing instruments return to default microphone program and default volume setting in that program)
When enabling and disabling a HI microphone during streaming, volume returns to default
Volume can only be turned up in the HI if there is reserve gain. If no reserve gain is present, there will be four ‘dead’ steps in the volume control

Key Lock:

When the key lock is activated, all other buttons are locked. An exception is in case of an incoming phone call, where the call can be accepted [even with key lock active] and all keys will be active until the call is terminated.

Wired Audio Input:

When a 2.5 mm jack is connected to the jack connector input of the communications device, it starts streaming after the audio button is pressed. The rim light (cf. e.g. rim 111 in FIG. 1b) around the audio button (cf. e.g. central push-button 112 in FIG. 1b) turns on constant light.
If Bluetooth audio streaming is active when the jack is inserted, the Bluetooth audio is stopped and the wired content is streamed instead. When the jack is removed, Bluetooth audio does NOT automatically resume but must be activated with the audio button.
If a phone call is active when the jack is inserted, the call is NOT terminated.
When the jack is removed, the communications device stops audio streaming and the hearing instruments returns to standard program.
If the audio button is pressed without a jack connected, streaming will not start.

USB Connector:

The communications device battery is charged via the USB connector. It can be connected to a PC for charging as well as to an adapter. See below for visual indication during charging and ‘battery low’-status.

The communications device has full functionality while charging.

The communications device firmware can be updated via the USB connector when connected to a PC.

Microphone:

The microphone in the communications device is on only during an active phone call. In all other situations the microphone is turned off.

Call Waiting:

The communications device supports call waiting by sending a notification to the hearing instruments when a second call is incoming during an active call. The notification will be played as beeps in the instruments, cf. below. To switch to the second call the mobile phone must be operated.

In-Band Ringing:

The communications device does not support in-band ringing. The ring tones of the communications device are always played by the hearing instruments. Note that in-band ringing will temporarily interrupt the audio streaming of the communications device. Similarly a mobile phone will interrupt audio streaming if the phone is configured to stream all audio over Bluetooth (e.g. button presses).

Audible Notification:

The audible notification is designed to notify the user of any events requiring user interaction. The audible commands are managed by the firmware of the communications device. Whenever an event requires an audible notification, the communications device should send a packet to request a sound playback. This packet includes a sound ID number to indicate which sound should be played.

The events requiring audible notification are:
Telephony
   Incoming call
   Incoming SMS
   Redial last number
   Reject call
The communications device interactions
   Bluetooth
      Enabled
      Disabled
      Bluetooth connection lost

The notification signals could be stored in the HIs.

Each instance of a notification should be triggered individually to ensure that the HIs will not continue to ring if the communications device is out of range when the ringing is terminated.

The audible notifications can be embedded into an audio stream. The status message of the communications device carries a beep-field, which is used to specify the type of audible notification required, in the same manner as the beep packet does.

During Idle:

A major issue in this scenario is to ensure that both HIs starts ringing at the same time. Even small delays from HI to HI will cause undesirable echo effects. When the communications device is not streaming, the Ring command is sent in a continuous burst mode, similar to remote control.

During Streaming:

During streaming the communications device should change the beep section of the communications device status message to request the required beep. To ensure that the HIs start ringing at the same time the “start ringing” should only be requested at an interval which is longer than the ring tone itself. Alternatively, the beeps could be mixed into the audio signal, to allow the communications device to stream beeps not included in the HI.

Stop Ringing:

Whenever the user acknowledges an event causing the audible notification, the ringing should cease immediately, to confirm the user interaction. The stop ringing signal is used for this purpose.

When a Stop Ringing signal is received by the HIs, they should cease ringing even though they are in the middle of a melody. Ringing is not normally stopped by an audio stream. This is only the case when the beep field of the communications device status message is set to “cease beep”.

Audible Feedback:

The audible feedback is quite similar to audible notification; however the feedback is initiated by a user interaction directly interacting with the HIs. This direct interaction allows the HIs firmware to manage the audible feedback, and thus no specific audible feedback packet is required as the information lies implicitly in the controls sent. The dependency on the command alone enables the HIs to choose a sound to play based on both the command, and the HIs current state, rather than be dependent on a command to play a specific sound. This for instance enables the HI to play a different sound when receiving a volume up command, depending on whether is at the upper limit, or operating normally.

These user interactions are:
Program change
Volume change
Connection to hearing aid(s) lost

Visual Notification:

It is a general principle of the present user interface that the status of the communications device is communicated to the user visually with lights, while the status of the hearing instrument is communicated with audio signals played in the hearing instrument. Table 1 below provides an overview of the visual indications, i.e. the different light and blinking patterns, of the embodiment of a communications device according to the disclosure illustrated in FIG. 1 providing feedback to the user about the current state.

TABLE 1
Visual indications versus events or state for buttons and indicators.

| | State | | |
|---|---|---|---|
| Light | description | Prerequisites | Blinking |
| Phone [symbol] | Phone ringing Phone call accepted | Streamer is paired and connected to mobile phone Streamer is paired and connected to mobile phone | Blinking GREEN light Constant GREEN light |
| | No active | | No light |
| | calls | | |
| Audio [symbol] | Streaming is on Streaming is off | Connection is established to Bluetooth or wired connection is present | Constant YELLOW light No light |
| | Streaming is | Connecting to | Slow flash |
| | pending | Bluetooth audio | YELLOW light |
| | | dongle (up to 30 | until audio |
| | | seconds) | connection is |
| | | | established |
| Bluetooth [symbol] | Bluetooth is turned on Pairing Bluetooth is turned off | Pairing is activated | Slow fading BLUE light Fast BLUE blinking No light |
| | Button | Key lock OFF | Constant BLUE |
| | pushed | | light for 5 seconds |
| | After any | Key lock ON | 10 5 short blinks |
| | button | | in 1 second |
| | pushed | | |
| Backlight [symbol] | After any button pushed Battery low | Key lock OFF ~20 minutes left | Backlight will light up for 10 seconds Constant RED light. audible notification sent to HI |
| Battery low [symbol] | Battery very low Battery near- dead | ~5 minutes left ~1 second left | Blinking RED light. Audible notification sent to HI Pressing button will turn on PhCStreamer shortly and blink RED light 3 times |
| | Battery dead | 0 minutes left | No response |
| Battery charging [symbol] | Battery charging Battery fully charged | USB cable connected to power source USB cable connected to power source | Blinking GREEN light 100 ms 0n/900 ms off Constant GREEN light |

The features audio-visual described above can e.g. be implemented in a combination of software and hardware and be located in the communications device.

Embodiments of the disclosure defined by the features of the independent claim(s). Preferred embodiments are defined in the dependent claims. Any reference numerals in the claims are intended to be non-limiting for their scope.

Some preferred embodiments have been shown in the foregoing, but it should be stressed that the disclosure is not limited to these, but may be embodied in other ways within the subject-matter defined in the following claims.

### REFERENCES

WO 2006/023857 A1 (MICRO EAR TECHNOLOGY) Mar. 2, 2006
EP 1 460 769 A1 (PHONAK) Sep. 22, 2004
WO 2006/117365 A1 (OTICON) Nov. 9, 2006
EP 1 328 136 (SIEMENS AUDIOLOGISCHE TECHNIK) Jul. 16, 2003
US 2007/0009123 (Aschoff et al.) Jan. 11, 2007

1. A body worn communications device for communicating with a head-worn listening device, the communications device being adapted for receiving a multitude of audio signals and for transmitting at least one audio signal selected among the multitude of audio signals to the listening device, the communications device comprising a number of functional push-buttons for influencing the selection and properties of said audio signals, the communications device comprising a user interface comprising a number of functional push-buttons for influencing the state of the user interface and wherein the state of the user interface is indicated at the same button where the state can be influenced.

2. A body worn communications device according to claim 1 adapted to indicate events relating to said received audio signals to a user by a mixture of audio and visual cues, wherein a visual cue is provided via one or more of said push-buttons.

3. A body worn communications device according to claim 1 wherein the communications device is adapted to provide that the commands activated by said push-buttons are defined dependent upon a push-time parameter and/or of the simultaneous activation of two or more push-buttons.

4. A body worn communications device according to claim 2, wherein said visual cues for a given button are selected from the group consisting of a symbol on the button, button rim lights, back light, different colour light, constant light, no light, blinking light at a first blinking frequency, blinking light at a second blinking frequency, and combinations thereof.

5. A body worn communications device according to claim 2, wherein said audio cues for a given button and/or event are selected from the group consisting of ring-tones, clicks, single beep-sounds, a relatively short beep, a relatively long beep, a number of repeated beep-sounds at a first repeat frequency, a number of repeated beep-sounds at a second repeat frequency, and combinations thereof.

6. A body worn communications device according to claim 1, wherein the status of the communications device is communicated visually with lights, while the status of the listening device is communicated with audio signals played in the listening device.

7. A body worn communications device according to claim 1, comprising a phone button for initiating commands and displaying events relating to the audio signal from a telephone and an audio button for initiating commands and displaying events relating to another audio signal.

8. A body worn communications device according to claim 1, further comprising a microphone for recording a user's voice input.

9. A body worn communications device according to claim 1, further comprising a volume control button for regulating the volume of the audio signal presented to the listening device.

10. A body worn communications device according to claim 1, comprising a wireless audio input interface.

11. A body worn communications device according to claim 10 comprising a wireless communications button for activating or de-activating the wireless communications interface.

12. A body worn communications device according to claim 1, further comprising a wired audio input connector.

13. A body worn communications device according to claim 1, further comprising a connector for charging the battery of the communications device and/or for updating the firmware of the communications device.

14. A body worn communications device according to claim 1, comprising four push buttons: a phone button, an audio button, a volume button and a wireless connection button.

15. A body worn communications device according to claim 1, further comprising a battery status indicator.

16. A body worn communications device according to claim 1, wherein the communications device is adapted to provide one or more tactile cues to indicate commands, status or events in said communications device or in said listening device.

17. A body worn communications device according to claim 1, wherein the push-buttons of the communications device are arranged so that they can all be manipulated by a thumb of a normal human hand substantially without moving the grip on the device.

18. A body worn communications device according to claim 1, wherein the push-buttons of the communications device are arranged on the same side of a housing of the communications device, within 7 cm of each other.

19. A hearing aid system comprising a communications device according to claim 1, and a listening device wherein the listening device and the communications device are adapted to communicate wirelessly with each other.

20. A hearing aid system according to claim 19 wherein the listening device and the communications device are adapted to communicate inductively with each other.

21. A hearing aid system according to claim 19 wherein the communication between the listening device and the communications device is arranged according to a communications standard.

22. A hearing aid system according to claim 19, wherein the bit rate of the audio signal is larger than 16 kHz.

23. A hearing aid system according to claim 19, adapted to allow the listening device to differentiate in the processing of the audio signals received from the communications device.

24. A hearing aid system according to claim 23 wherein the system is adapted to exchange status information between the communications device and the listening device and wherein an audio identification field is included in said status information.

25. A hearing aid system according to claim 19, wherein the listening device comprises a hearing aid or a pair of hearing aids, a head set or a pair of head phones.

26. A hearing aid system according to claim 19, adapted to provide that the status of the communications device is communicated visually with lights, while the status of the listening device and/or events related to an audio signal received by the communications device is communicated with audio signals played in the listening device.

27. A hearing aid system according to claim 26 adapted to provide that the audio signals to be played in the listening device are stored in a memory in the listening device.

28. A hearing aid system according to claim 26 adapted to provide that the audio signals to be played in the listening device are stored in a memory of the communications device and forwarded to the listening device for being played.

29. A method of indicating to a user a) commands activated by push-buttons of a body worn communications device for communicating with a head-worn listening device, and b) the status of the communications device and/or of the listening device;
the communications device being adapted for receiving a multitude of audio signals and for transmitting at least one audio signal selected among the multitude of audio signals to the listening device;
the communications device comprising a number of functional push-buttons for influencing the selection and properties of said audio signals;
the method comprising indicating to a wearer of the communications device states relating to said audio signal(s) received by the listening device and influenced by the wearer at the same button where the state in question was influenced.

30. A method according to claim 29 comprising indicating said commands and status relating to said audio signal(s) received by said communications device and/or said listening device to a wearer of said listening device by a mixture of audio and visual cues wherein the commands and status of the communications device is communicated visually with lights in or around said push-buttons, while the status of the listening device is communicated with audio signals played in the listening device.

31. A method according to claim 30 wherein said visual cues for a given button and/or status indicator are selected from the group consisting of a symbol on the button, button rim lights, back light, different colour light, constant light, no light, blinking light at a first blinking frequency, blinking light at a second blinking frequency, and combinations thereof.

32. A method according to claim 30 wherein said audio cues for a given button and/or event are selected from the group consisting of ring-tones, clicks, single beep-sounds, a relatively short beep, a relatively long beep, a number of repeated beep-sounds at a first repeat frequency, a number of repeated beep-sounds at a second repeat frequency, and combinations thereof.

33. A method according to claim 29 comprising providing indications of commands or status in said communications device or in said listening device by one or more tactile cues.

34. (canceled)
